(19) United States
(12) Patent Application Publication
(10) Pub. No.: US 2026/0216965 A1
(43) Pub. Date: Jul. 30, 2026

(54) METHOD FOR RECYCLING SCRAP FROM THERMOPLASTIC COMPOSITE MATERIALS

(71) Applicant: DAHER AEROSPACE, ORLY (FR)

(72) Inventors: Julie VAUDOUR, PONT SAINT MARTIN (FR); Julie DAUSSEINS, SAINT HEBLAIN (FR)

(21) Appl. No.: 19/151,980

(22) PCT Filed: Feb. 2, 2024
(86) PCT No.: PCT/EP2024/052662

§ 371 Date: Jul. 29, 2025

(30) Foreign Application Priority Data
Feb. 2, 2023 (FR) FR2301010

(51) Int. Cl. B29C 70/08; B29C 45/00; B29C 64/118; B29C 65/00; B29C 70/00; B29C 70/12; B29C 70/16; B29C 70/34; B29C 70/84; B29K 71/00; B29K 81/00; B29K 105/26; B33Y 10/00; B33Y 40/20; B33Y 70/10

(52) U.S. Cl. CPC B29C 70/081; B29C 45/0005; B29C 64/118; B29C 66/72141; B29C 66/72143; B29C 70/003; B29C 70/12; B29C 70/16; B29C 70/34; B29C 70/84; B33Y 10/00; B33Y 40/20; B33Y 70/10; B29C 2793/0027; B29C 2793/009; B29K 2071/00; B29K 2081/04; B29K 2105/26

(57) ABSTRACT

The invention relates to a method for recycling scrap from parts made of composite material reinforced with continuous fibers in a thermoplastic polymer matrix, the method comprising the steps consisting in: i) obtaining a composite preform (110, 500) which is continuously reinforced and is suitable for obtaining a structural part; ii) obtaining the structural part (200, 400) from the composite preform which is continuously reinforced; iii) cutting out the structural part (200, 400); iv) recovering (310) the scrap (120, 220) produced in steps i) and iii); v) grinding (320) the scrap to obtain a ground material consisting of pieces of composites; vi) compounding (330) the ground material obtained in step v) to obtain a compound; vii) obtaining a second composite part (410, 600) by shaping the compound obtained in step vi).

### TECHNICAL FIELD

The invention belongs to the field of implementation of composite materials with a thermoplastic polymer matrix. More particularly, the invention belongs to the field of recycling, in particular, but not exclusively, in the context of a circular economy.

### BACKGROUND ART

Thermoplastic polymer matrix composite materials, more particularly continuous fiber reinforced composites, have many advantages in terms of processing, mechanical and chemical characteristics, more particularly, but not exclusively for aircraft manufacturing.

The ability to implement these materials by techniques that are similar to that of processing metallic materials, in particular, but not exclusively by stamping, leads to material scraps during their processing resulting, for example, from the cutting of sets of blanks and the trimming of the shaped parts.

These scraps may account for up to 50% of the material used, in a large-series production, or even more when the production stream does not allow for the optimization of blank sets.

While the thermoplastic polymer making the matrix is generally considered as recyclable, the same is not true for the composite, where the scraps of said composite are a mix of polymer and fibers.

However, more particularly in the aeronautical field, both the polymer making the matrix and the reinforcing fibers are high-performance and high-cost materials.

In addition, specifically in the aeronautical field, the material shall be qualified and for this purpose shall meet quality assurance and traceability requirements during its development, which further increases its value, or more precisely, the value loss associated with the landfill of these scraps when made of a material qualified for aeronautics.

From an overall point of view, methods for separating the matrix from the fibers in order to direct them towards separate recycling streams are not economically nor energetically viable to date.

In addition, the diversity of fiber content, polymer matrices and part thicknesses make open loop recycling difficult.

Document WO2021/259757 describes a method for recycling CF/PEKK composite scraps.

The document DAY R et al.: “Recycling of APC-2 offcuts”, MANUFACTURING COMPOSITES, BUTTERWORTH SCIENTIFIC, GUILDFORD, SURREY, GB, vol. 5, no. 3, 1 Sep. 1994(1994 -09-01), pages 187-193, describes a method for recycling scraps of CF/peek prepreg blanks.

Document EP 0 643 093 describes the recycling of glass fibre reinforced composites in a polypropylene thermoplastic matrix.

### SUMMARY OF THE INVENTION

The aim of the invention is to improve the rate of use of the material by making the most of the scraps during its implementation.

To this aim, the invention pertains to a method for making two composite parts comprising a structural part made of a composite material reinforced by continuous fibers with a volume content of continuous fibers in a matrix made of a first thermoplastic polymer with a first melting temperature, and a composite part comprising a fibrous reinforcement comprising segments of continuous fibers according to a staple fiber content and a thermoplastic matrix with a second melting temperature and comprising the first thermoplastic polymer, the method comprising the steps of:
i) obtaining a composite preform with a continuous reinforcement and adapted to obtain the structural part;
ii) obtaining the structural part from the composite preform with continuous reinforcement;
iii) trimming the structural part;
   wherein steps i) and iii) make scraps, the method further comprising the steps of:
iv) collecting the scraps made in steps i) and iii);
v) shredding the scraps collected in step iv) for obtaining a comminuted product;
vi) compounding the comminuted product obtain in step v) for obtaining a compound;
vii) obtaining the second composite part by shaping the compound obtained in step vi);

This method enables to make the best use of the material, in particular the material with high added value such as composites with a thermoplastic matrix and high-performance fibers.

According to a surprising effect, the method enables to make a part reinforced with staple fibres with a fibre content higher than what is possible to obtain with the methods of the prior art and commercially available compounds.

The invention may be implemented according to the embodiments and variants exposed hereafter, which are to be considered individually or according to any technically operative combination.

According to an exemplary implementation the first polymer is a PPS, the volume content of continuous fibers is greater than 40% and the volume content of staple fibers is greater than 40%.

Preferably, a greater length of the composite segments obtained in step v) is comprised between 2 mm and 15 mm, preferably between 4 mm and 10 mm and more preferentially between 8 mm and 10 mm.

Advantageously, step v) comprises shredding with a chipper with knives in which a rake angle γ of the knives is comprised between 30° and 40°, a relief angle α is comprised between 20° and 30° and a wedge angle β is at least 30° with α+β+γ=90°.

This type of knife allows a clean cut of the scraps and greatly reduces the risk of jamming.

According to some embodiment, step vi) comprises adding to the shredded scraps during the compounding, a second polymer having a third melting temperature and miscible in the first polymer. This addition enables to control both the fiber content in the granulate and the melting temperature of the granulate.

Therefore, a third melting temperature of the second polymer may be lower, higher or equal to the one of the first polymer.

According to an embodiment, the compounding step vi) is performed in an extrusion device comprising an assembly of a plurality of screw segments, a screw segment comprising a heating sleeve and a screw comprising a feeding area, a heating zone and a kneading zone, said extrusion device comprising at least two segments downstream of a comminuted product feeding point in a material moving direction in the extrusion device.

According to some embodiment, the first polymer is selected from PEEK, PEK and PAEK and the second polymer is selected from PEEK PEK, PAEK and LMPAEK, the volume content of continuous fibers is greater than 50% and the volume content of staple fibers is greater than 40%.

Advantageously, during step vi) the feeding point of the comminuted product into the extrusion device is located at least two segments downstream of the feeding point of the second polymer in the moving direction of the material.

According to some embodiment, the compound obtained in step vi) is a spooled wire and step vii) is carried out by additive manufacturing implementing a melting of the wire.

According to another embodiment, the compound in step vi) is in the form of pellets and step vii) is carried out by plastic injection molding.

Thus, the method of the invention offers several alternatives for the manufacturing of the part reinforced by staple fibres.

According to a particular embodiment the method comprises after step vii) a step of:
viii) bonding the second composite part to the structural part.

According to the latter embodiment, steps vii) and viii) are carried out by overmolding the attached part on the structural part.

According to another variant, step viii) is performed by welding the attached part on the structural part.

According to yet another variant, step viii) is carried out by co-consolidation of the attached part and the structural part.

Of course, two or more of these variants may be combined when making a same structural part.

Thus, according to an embodiment, the outcome of adding a virgin polymer to the comminuted product prior to the compounding, is the second melting temperature being higher than the first melting temperature. This embodiment is for example adapted for making an assembly of the second part on the structural part by overmolding or by co-consolidation.

Alternatively, the outcome of this virgin polymer addition is also to obtain a second melting temperature lower than the first melting temperature. This embodiment is for example adapted for making the second part by plastic injection molding.

According to an exemplary embodiment, the first polymer is an LMPEAK, and the second polymer is selected from PEEK and PEKK.

According to another exemplary embodiment, the first polymer is a PEI and the second polymer is selected from peek, PEKK and LMPAEK.

These two embodiments lead to a compound having a melting temperature higher than that of the polymer making the matrix of the structural part, these embodiments being more suitable for overmolding and co-consolidation.

Alternatively, the inverse combinations make a compound whose melting temperature is lower than that of the polymer of the matrix of the structural part.

### BRIEF DESCRIPTION OF THE DRAWINGS

The invention is implemented according to the preferred embodiments, in no way limiting, exposed hereafter with reference to FIGS. 1 to 8 in which:

FIG. 1 is a top view of an example of a set of blanks cut out in a consolidated plate reinforced by continuous fibers;

FIG. 2 shows, from a perspective view, simplified examples of trimmings carried out on a structural part obtained by stamping one of the blanks of FIG. 1;

FIG. 3 is a flowchart summarizing the method of the invention;

FIG. 4 is a perspective and exploded view of an example of a spar made by implementing the method of the invention;

FIG. 5 shows, according to a perspective and exploded view, an exemplary embodiment of a tooling for making the spar of FIG. 4;

FIG. 6 shows, according to two views in perspective from above and below, an exemplary embodiment of a rudder pedal made by implementing the method of the invention.

FIG. 7 shows according to a front view an exemplary embodiment of a chipper knife suitable for shredding composite scraps with a detailed view of the sectional area showing characteristic angles;

FIG. 8 is a schematic sectional view of a screw segment of an injection device.

### DESCRIPTION OF EMBODIMENTS

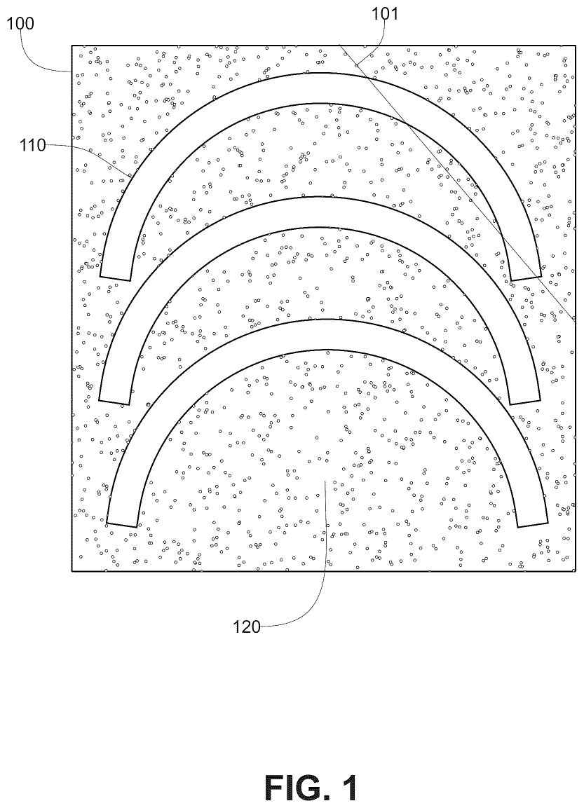

FIG. 1, according to some embodiment, a thermoplastic matrix composite part is obtained from a blank (110), i.e. an essentially flat blank trimmed according to a suitable contour, which blank is stamped between a punch and a die after said blank has been heated to a temperature of the order of the melting temperature of the polymer matrix.

According to some embodiment, the blank (110) is for example cut from a fiber-reinforced consolidated composite plate (100) comprising continuous fibers (101), that is to say fibers extending continuously from one edge to another of the consolidated plate (100) and which, after cutting the blank, extend from one edge to another of the blank (110).

By way of non-limiting examples, the plate (100) consists of a thermoplastic polymer PEEK (polyetheretherketone), PEKK (polyetherketoneketone), PAEK (polyaryletherketone), PEI (polyetherimide), PPS (polyphenylene sulfide) or any other thermoplastic polymer.

The fibrous reinforcements are carbon, glass or aramid fibers without these examples being limiting.

The blank is cut, for example, by means of a high-pressure abrasive water jet.

Several blanks, organized in a set, are cut from such a plate (100). However, even by optimizing the nesting of the blanks cut in the plate, there remains a scrap in the form of a skeleton (120, filled with dots in the figure) which represents a significant part of the mass of the initial plate, typically between 30% and 50% of the volume of the consolidated plate before cutting out the set.

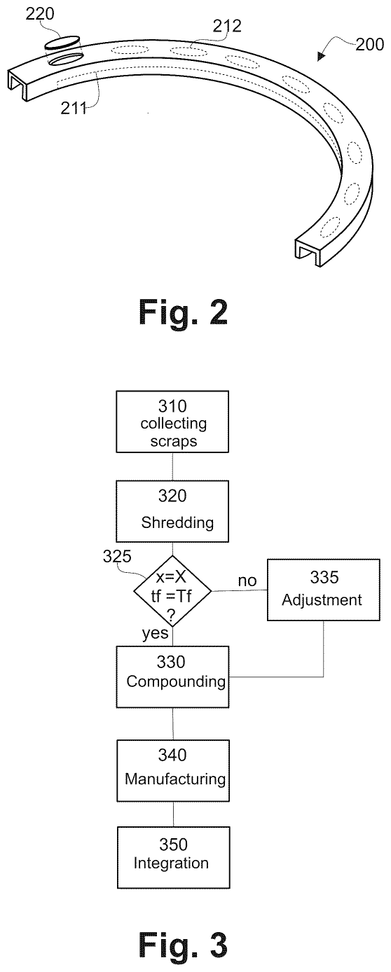

FIG. 2, after stamping, the part obtained is trimmed on its edges to eliminate an unconsolidated part, inherent in the stamping process, and is also trimmed in current section along various paths (211, 212), in particular to create openings therein.

For example, these trimmings are carried out in milling and also produce scraps (220) made of the same material as the structural part (200).

According to prior art, these scraps, both the skeleton and those resulting from the trimming of the raw stamped part, are discarded and shall be treated according to a specific waste disposal process, which leads to additional costs.

To date, there is no industrial value chain for recycling waste from these composite materials reinforced by continuous fibres.

At best, these scraps are burned in a process called energetical valuation, which emits greenhouse gases.

Recycling difficulties are due, in particular, to the blending of the polymer making the matrix with fibrous reinforcements and, on the other hand, to the diversity of materials treated both from the point of view of matrices, reinforcing fibres and thicknesses, at the scale of an industrial production facility.

Given the sorting operations that would be necessary, the difficulty to visually differentiate the nature of the waste and the low value of the waste as such, such recycling operations according to conventional industrial processes impact production costs too much to the point that, to date, it remains more profitable to pay for special waste treatment than to set up a process allowing external recycling.

In addition, the methods for obtaining composite parts with thermoplastic matrix and continuous fibrous reinforcement are not limited to the stamping of blanks cut out from consolidated plates but may implement other methods such as partially consolidated blanks obtained by fiber placement, consolidation of unconsolidated plies, etc. without these examples being neither exhaustive nor limiting.

However, whatever the method, scraps are produced, these scraps consisting of materials with equivalent composition but having undergone different thermal histories, depending on the method implemented for the manufacturing of the parts reinforced with the continuous fibres, thermal histories which result in different cohesions and in particular different porosity rates, even if the latter remain within strict acceptable limits.

The invention relates to a so-called internal recycling in which the scraps are used, after appropriate treatment as described below, as a material for the production of parts with non-continuous reinforcement.

The method of the invention also has the advantage of being able to combine scraps of the same material but from different processing methods by erasing the thermal histories associated with these methods and providing a homogeneous material.

However, surprisingly, the process of the invention takes advantage of the prior implementation of the material by making it possible to achieve reinforcement contents higher than what is possible to obtain by using a raw material not derived from the method of the invention.

In industrial fields where the material shall be pre-qualified, in particular in the aeronautical field, the material obtained by the method of the invention benefits, at least partially, from the qualification of the material from which the scraps are derived, thus facilitating this qualification process.

In some embodiments, for the manufacture of parts comprising a structural part (200) reinforced with continuous fibers to which are attached other parts such as brackets or cleats, these added parts, obtained from scraps issued from the manufacturing of the structural part, are particularly adapted to be integrated without mechanical fixing with said structural part, or into a structural part resulting from the same batch, by methods such as welding, co-consolidation or overmolding, with perfect miscibility of the polymers at stake.

Thus, the parts obtained from the material recycled from the scraps, are generally parts with high added value because of their high reinforcement ratio and the nature of their polymer matrix and directing the scraps towards a perfectly identified use in a production unit, greatly increases the profitability of the operation.

FIG. 3, to this end, the invention relates to a method comprising a first step of collecting scraps (310).

According to a particular non-limiting embodiment, the scraps are assigned to the same production process as that of the structural part so that they remain, for example, referenced in the ERP in the same general production process sheet.

### Shredding

According to a shredding step (320) the scraps are shredded so as to make sections of appropriate length.

According to some embodiment, the shredding comprises a first crushing step, aimed at bringing the scraps into sections, a greater length of which is comprised between 10 mm and 100 mm, preferably between 10 mm and 50 mm.

Alternatively, the scraps can be cut into such sections with the blank trimming means.

Following the crushing operation, a sieving is performed to eliminate sections with a length of less than 10 mm.

Shredding is preferably carried out by a slow-speed knife chipper, making sharp cuts of the sections without squashing and without delamination at a distance from the edges of the sections.

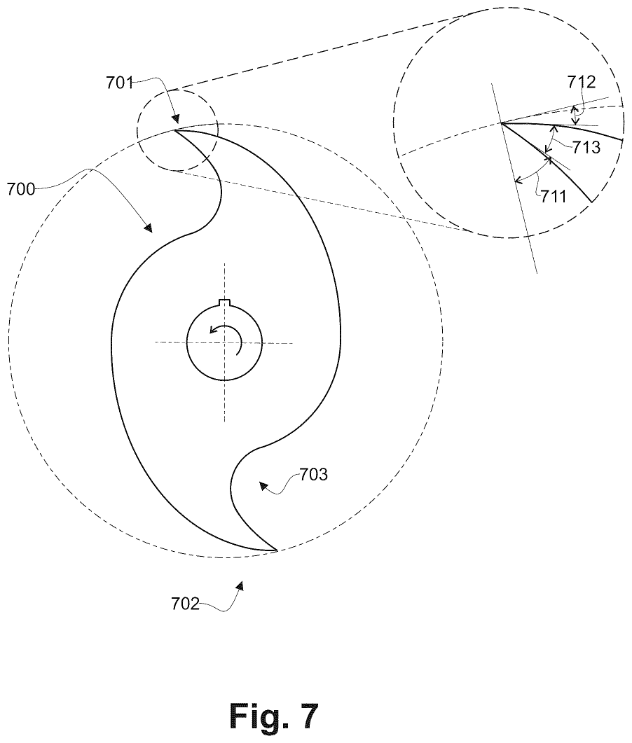

For this purpose FIG. 7, the chipper preferably implements knives (700) adapted to the composite, avoiding excessively high cutting forces and preventing jamming.

According to an exemplary embodiment, a knife comprises 2 teeth (701, 702) thus offering clearance (703) compared to traditional knives that are used in particular in injection sprue scraps of non-reinforced plastic material.

According to this exemplary embodiment, each of the two teeth has a rake angle γ comprised between 30° and 40°, preferably between 35° and 40°, so as to reduce cutting forces, a α relief angle comprised between 20° and 30° for limiting jamming and a wedge angle β of at least 30° so as to achieve a thick enough section of the tooth, with α+β+γ=90°.

In addition, the very positive rake angle promotes a clean cut of the scraps maintaining the cohesion between the polymer making the matrix and the fibers.

Following the shredding operation, the comminuted product is sieved so as to eliminate sections with a length of less than 2 mm, according to a preferred embodiment, the comminuted product is sieved to eliminate sections with a length of less than 6 mm.

The comminuted product is washed, in particular to eliminate any abrasive when the scraps are issued from a water jet cutting operation, any lubricant or any pollution the material has been exposed to during the cutting or implementation steps, potential metallic particles in the comminuted product may be removed by a magnetic filter, then the comminuted product is dried in an oven, for example at 150° C. during 6 hours.

Thus, the comminuted product comprises sections of which a greater average length is statistically comprised between 2 mm and 15 mm and preferably between 4 mm and 10 mm and more preferably between 6 mm and 10 mm at +/−3 standard deviations from the average. The comminuted product comprises both polymer and sectioned fibers from the continuous fibers of the structural part, the polymer being at least partially bound to the fibers.

The scraps are issued from cutting or trimming consolidated plates from sets of blanks or from semi-finished parts that have been consolidated, for example during stamping, shape consolidation or at least partial consolidation during fiber layup by high speed fiber placement, or preimpregnated plies. In fact, the material comprised in the scraps has, in most cases, already undergone a thermomechanical cycle comprising melting of the polymer making the matrix, compression, degassing for impregnation and intimate bonding of the reinforcements and the matrix and porosity contents of less than 5% or even commonly less than 2%.

### Compounding

According to a compounding step (330) the comminuted product is placed in an extruder in order to carry out a compounding.

Compounding is a method known from the prior art consisting in passing the comminuted product through a screw extruder in order to extrude a substantially cylindrical wire through a die.

Said wire is a composite wire comprising a thermoplastic polymer and staple fibers corresponding to the portions of reinforcing fibers initially continuous and included in the structural part and then present in the comminuted product.

The staple fibers may be short fibers with an aspect ratio I/d of less than 500 where I is the length of the fiber and d is the diameter of the fiber, or long fibers with an aspect ratio I/d of greater than 500. The length of the fibers depends on the dimensions of the segments in the comminuted product as well as the conditions for implementing the compounding operation.

However, the compounding implemented for waste recycling differs from a conventional compounding by at least two characteristics:
the reinforcements are already present in the comminuted product, whereas for conventional compounding the reinforcements are added as a filler to the molten polymer at the screw level during the extrusion;
the level of reinforcements in the comminuted product and in the extruded wire are much higher than what is conventionally used in compounding where the level of fibres rarely reaches 40%, whereas the recycling method enables to achieve reinforcements ratios greater than 40% or even greater than 50% by volume.

These differences have consequences on the conditions of implementation of the compounding step.

Thus, unlike a conventional compounding where the reinforcing filler is introduced either in the form of a filler alone or in the form of pre-compounded pellets comprising the filler and calibrated in shape, the reinforcement is here introduced in the form of a comminuted product of uncalibrated shape comprising a high content of fibres bound to the polymer.

The extruder is a single-screw or twin-screw extruder but whose L/D ratio of the total length of the screw to the diameter of the threaded part is preferably greater than 30 or even greater than 40. This configuration enables a better homogenization of the material.

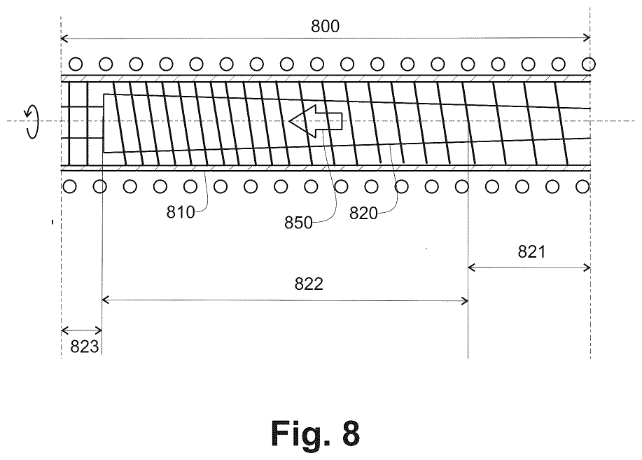

FIG. 8 according to a schematic embodiment, the extrusion device comprises a sleeve (810) in which one or two screws (820) rotate depending on whether it is a single-screw or twin-screw extruder.

The entire extrusion device consists of the assembly of several successive segments (800) as shown in FIG. 8.

Schematically, over such a segment (800) the screw (820) comprises a feeding area (821), a heating area (822), where the material is subjected to an intense mechanical stress which causes it to melt, and a mixing area (823) for homogenizing the material. The length of the different areas varies according to the extruders. The pitch of the worm screw as well as the depth of the threads are reduced when passing from the feeding area (821) to the end of the heating area (823) in the moving direction of the material (850).

Advantageously, the sleeve of the extrusion screw or screws is preheated to a temperature of the order of 0.8 to 0.9 Tf where Tf is the melting temperature in Celsius of the polymer making the matrix of the comminuted product. This preheating of the sleeve enables to raise the temperature of the material faster than under the sole effect of the compression and shearing imposed on it by the worm screw (820).

During extrusion, under the effect of mechanical stress, the temperature in the sleeve reaches at least Tf.

The comminuted product is introduced into the feeding area (821) and the extrusion device comprises at least 2 successive segments (800) between the feeding point of the comminuted material and a third segment leading to the die, from which the extruded thread exits.

Thus, in the case of a direct compounding of the comminuted product without material addition for example in the case of scrap form a PPS carbon composite, the extrusion device comprises at least 3 segments (800), two segments following the feeding of the comminuted material and a segment leading to the die.

In the case of a material addition, either to modify the melting temperature and/or to modify the fiber content, with reference to the moving direction of the material, the addition material is first introduced into the extrusion device, and the feeding of the comminuted product is performed at least one segment and preferably two segments (800) downstream of the point of introduction of the addition material in the progression direction of the material. Then, in the moving direction of the material, two segments (800) are necessary before a last segment leading to the die. Thus, in this configuration the extrusion device comprises at least 4 segments and preferably 5 segments (800).

Performing a preheating along the length of the extrusion device, as well as the minimum of two segments following the introduction of the comminuted product to the final segment leading to extrusion, are necessary to obtain good homogeneity of the material. It is possible to consider more than 2 segments between the introduction of the comminuted product and the last segment leading to the extrusion, however in such a case the length of the fibers in the extruded wire is reduced.

At the die outlet, the extruded wire is cooled in water. According to some embodiment, to avoid too abrupt cooling leading to stresses buildup in the wire which then distorts under their effect thereof, the cooling bath may be preheated to a temperature comprised between 70° C. and 95° C.

### Finishing

According to embodiments, the extruded composite wire is spooled for subsequent use, for example, in an additive manufacturing process implementing wire melting.

In this case, the process is adjusted, in particular at the compounding stage, to obtain a content and a length of staple fibers in the compound, compatible with the additive manufacturing process.

According to another embodiment, the extruded wire is cut into sections, for example of a length of the order of 2 mm, in order to form pellets suitable for plastic injection, said pellets comprising short fibres.

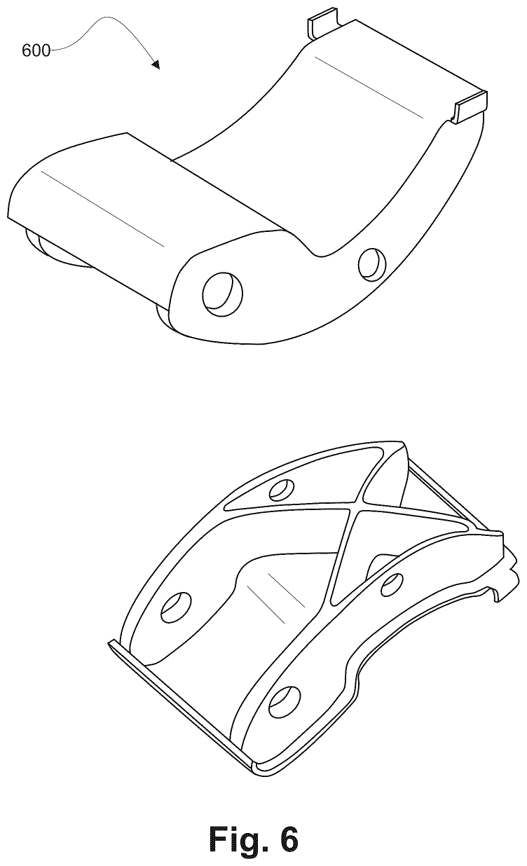

Plastic injection molding may then be used for the manufacturing of molded parts, as shown FIG. 6 according to some embodiment, or for the extrusion of profiles, tubes or plates.

### Adjustment

The achievable fiber content depends on the viscosity of the polymer at the compounding temperature, and on the ability of said polymer to impregnate the fibers so that the extruded wire remains cohesive.

Without being bound by any theory, it seems that the impregnation of the fibers by the polymer and the cohesion of the composite are, at least in part, inherited in the extruded wire, from the processing operations of the material making the scraps, during the manufacturing of the structural part.

Thus, the method enables the wire to maintain its cohesion with up to 60% in volume of fibers in the wire or pellets.

Such volume ratios of staple fibers are far beyond those obtainable in commercially available pellets which are not made according to the method of the invention.

The fiber content in the extruded wire may be controlled by adding polymer pellets or chips to the comminuted product during compounding, so as to achieve a fibers content lower than the one comprised in the scrap.

The polymer added upon compounding may be the same as the one comprised in the scrap, or be of a different nature, provided that it is miscible with the original polymer, or a combination thereof.

The addition of a different polymer, miscible in the first, also makes it possible to adjust the melting point of the wire or pellets.

Thus, if (325), after shredding, the fibre content x of the comminuted product is equal to the aimed fibre content X in the pellets and if a melting temperature tf of the comminuted product is equal to the aimed melting temperature Tf for the pellets, then the compounding is carried out directly from the comminuted product. Otherwise during an adjustment step (335), a polymer is added to the comminuted product during compounding.

The polymer added during the adjustment step is be miscible with the first polymer constituting the matrix of the scraps It may be the same polymer and in such a case only the fiber content in the extruded wire is modified, or, it may be a different polymer, in sch a case, both the fiber content and the melting temperature of the wire are modified, with respect to the composite making the structural part.

As stated above, this filler polymer is preferentially introduced into the extrusion device upstream of the introduction of comminated material in the direction of material progression.

According some implementation, the polymer constituting the matrix of the scraps is of the family of poly(aryl ether ketone) PAEK and the polymer added during the adjustment step is also of the family of PAEK or a PEI.

PAEKs are a family of thermoplastic polymers with high stability at high temperatures as well as high mechanical characteristics, they are therefore particularly suitable for aeronautical structural applications.

The PAEK family includes PEK, PEEK, PEKK, PEEKK, PEKEKK, PEEEK, PDEK and LMPAEK® the latter having a low melting point.

Thus, the second melting temperature of the polymer included in the constitution of the second part is a function of a third melting temperature of the filler polymer.

For example, if the scrap matrix consists of a low melting temperature PAEK (LMPAEK®), adding PEEK or PEKK to the comminuted product during compounding increases the melting temperature of the pellets.

Conversely, if the polymer making the matrix of the scraps is for example a PEEK, the addition of LMPAEK® or PEI to the comminuted product during the compounding operation enables to lower the melting temperature of the pellets in comparison with the melting temperature of the polymer making the matrix of the scraps.

The extruded wire or the pellets are used to make a staple fiber-reinforced part during a manufacturing step (340), by additive manufacturing, or by a plastic injection molding process.

According to some embodiment, the part made during this manufacturing step (340) is assembled to a structural part during an integration step (350), preferably by a fixture free method.

As non-limiting examples of such methods are:
overmolding, during which the attached part is injected directly onto the structural part, in such a case the adjustment step (335) preferably aims to obtain a pellet having a melting temperature higher than that of the polymer making the matrix of the structural part;
co-consolidation, in such a case the adjustment step (335) preferably aims to obtain a pellet having a melting temperature higher than that of the polymer constituting the matrix of the structural part;
welding, in such a case the adjustment step (335) possibly aims to lower the content of staple fibers in the pellet without changing the melting temperature.

According to some embodiment, the structural part is an aircraft frame and the attached part is a bracket or a cleat attached to that frame.

The compounding step subjects the comminuted product to severe thermomechanical stresses melting the material. Such stresses erase the cohesion defects, even small, present in the scraps that may have been introduced by implementation methods including trimming, for example, eliminating porosities and delaminations, although surprisingly the method of the invention takes advantage of the impregnation of the fibers and the homogeneity of the material obtained during previous implementations of the structural part such as consolidation, stamping, etc.

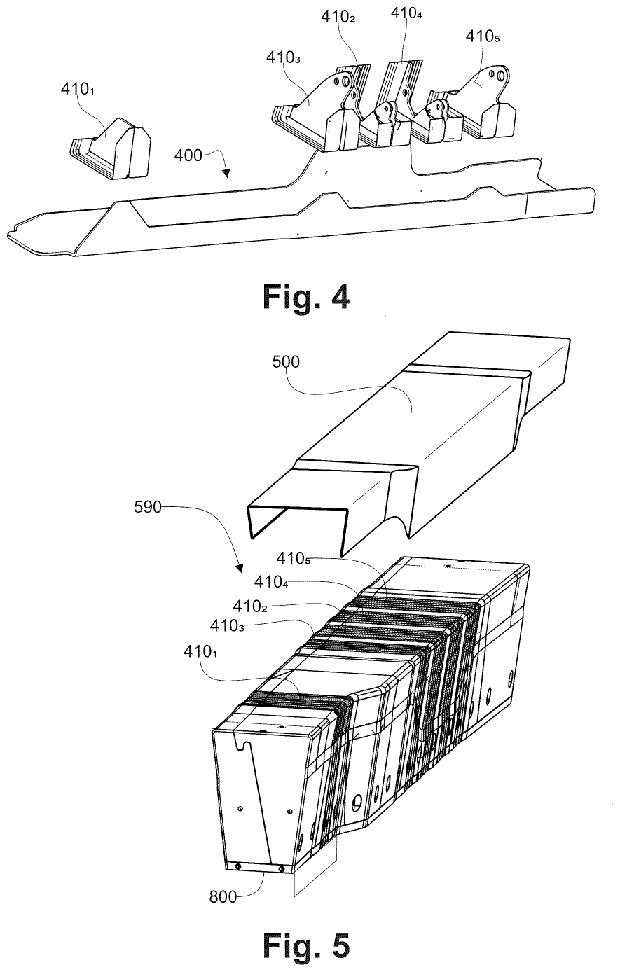

FIG. 4 according to another example, the structural part is a spar (400) made of a PAEK thermoplastic matrix composite with reduced melting temperature (LMPAEK ®) and comprising a continuous fibrous reinforcement of carbon fibers corresponding to 60% by volume of fibers (66% by mass).

Said spar comprises a plurality of ribs (410₁ . . . 410₅). According to some embodiment, said ribs are made by plastic injection molding with pellets obtained from trimming scraps of said spar (400), in practice, from one or more similar spars previously manufactured and trimmed.

The scraps are shredded and a polymer of the PEEK or PEKK type, miscible in LMPAEK®, is added so as to increase the melting temperature of the polymer matrix and reducing the fibers content in the pellets to a level of between 40% and 55% by mass. The high fiber content achievable by the method of the invention makes it possible to achieve the aimed mechanical characteristics for the ribs.

FIG. 5 according to some embodiment, the ribs (410₁ . . . 4105) are placed on a mandrel tooling (590), assembled such that the flanges of said ribs to be assembled with flanges of the spar are flush with the surface of the mandrel tool.

A spar preform (500) is laid up by plies over the mandrel tooling (590), for example by automatic fiber placement or by hand layup of nonwoven plies. The plies come into contact with the soles of the ribs placed in the mandrel tooling (590).

The assembly is then bagged in a sealed manner, evacuated and heated to a temperature equal to or higher than the melting temperature of the matrix of the preform (500).

This temperature is lower than the melting temperature of the polymer (modified during compounding) making the matrix of the ribs but remains high enough to activate autohesion and welding phenomena at the interfaces between said preform (500) and the ribs (410₁ . . . 410₅) without the latter losing their cohesion and distorting excessively.

The preform (500) thus undergoes a pressure-temperature cycle capable of consolidating the spar and integrating the ribs.

After demolding, the spar is trimmed to give it its final profile, the scraps resulting from this trimming may be used to manufacture pellets suitable for plastic injection molding of the ribs.

It should be noted that FIG. 4 and FIG. 5 represent a composite spar demonstrator. A person skilled in the art understands that the wing length is nearly 2 orders of magnitude greater than the width of the ribs, and that consequently the volume of waste collected during the final trimming is sufficient to produce several of these ribs.

FIG. 6 according to some other embodiment, scraps of a continuous carbon fiber-reinforced PPS matrix composite with a volume ratio of 50% (57% by weight) are shredded and then formed into pellets without the addition of a virgin polymer during compounding.

These pellets are used, for example, to obtain by injection molding, a rudder pedal for an aircraft. Such a part is conventionally made of an aluminum alloy, the shape of this part makes it difficult or impossible to make it of composite with continuous reinforcement, and its manufacturing by plastic injection molding from a commercially available granulate, on the one hand, does not make it possible to achieve sufficient reinforcement ratios and, on the other hand, would require a qualification of the material. Using pellets obtained from scraps of aeronautical parts makes it possible to solve these two issues, with an injected part (600) comprising 57% of fibres by mass (50% by volume) and consisting of a material already qualified.

The above examples show that the invention achieves the intended purpose and makes it possible to recycle, according to a high added value process, composite manufacturing scraps formerly treated as ultimate waste.

1-20. (canceled)

21. A method for making two composite parts comprising a structural part made of a composite material reinforced by continuous fibers with a volume content of fibers of at least 50% in a matrix made of a first thermoplastic polymer with a first melting temperature, and a second composite part comprising a fibrous reinforcement comprising staple fibers as continuous fibers segments according to a staple fibers content and a thermoplastic matrix with a second melting temperature and comprising the first thermoplastic polymer, the method comprising steps of:
i) obtaining by fibers layup a composite preform with a continuous reinforcement and adapted to obtain the structural part;
ii) obtaining the structural part from the composite preform with continuous reinforcement by subjecting the composite preform to a consolidation thermomechanical cycle comprising melting the first thermoplastic polymer and a compression of the composite preform;
(iii) trimming the structural part;
wherein at least step (iii) produces scraps, further comprising steps of:
iv) collecting the scraps produced at step iii);
v) shredding the scraps collected in step iv) for obtaining a comminute made of scraps segments;
vi) compounding the comminute obtained in step v) in a screw extrusion device, where compounding comprises adding a second polymer having a third melting temperature and being miscible with the first thermoplastic polymer, a comminute feeding point in the screw extrusion device being downstream of a second polymer feeding point in a material moving direction in the screw extrusion device, for obtaining a compound;
vii) obtaining the second composite part by shaping the compound obtained in step vi).

22. The method of claim 21, wherein the first thermoplastic polymer is a PPS and wherein the staple fibers content is greater than 40% in volume.

23. The method of claim 21, wherein the second composite part is obtained by plastic injection molding.

24. The method of claim 21, wherein a greater length of the scraps segments obtained in step (v) is comprised between 8 mm and 10 mm.

25. The method of claim 21, wherein step v) comprises shredding with a chipper with knives in which a rake angle y of the knives is comprised between 30° and 40°, a relief angle a is comprised between 20° and 30° and a wedge angle β is at least 30° with α+β+γ=90°.

26. The method of claim 21, wherein the screw extrusion device comprises a worm screw with a worm screw length L and a worm screw diameter D, with L/D comprised between 30 and 40, and comprises an assembly of a plurality of screw length sections, a length section comprising a heating sleeve and a screw comprising a feeding zone, a heating zone and a kneading zone, in the material moving direction, the screw extrusion device comprising at least two length sections downstream of the comminute feeding point in the material moving direction.

27. The method of claim 26, wherein in step vi), the heating sleeve is preheated to a temperature comprised between 0.8 Tf and 0.9 Tf where Tf is the first melting temperature in Celsius.

28. The method of claim 21, wherein the first thermoplastic polymer and the second polymer are of a poly(aryl ether ketone) type and the staple fibers content is greater than 40% in volume.

29. The method of claim 28, wherein the first thermoplastic polymer and the second polymer are of the poly(aryl ether ketone) type, the staple fibers content is greater than 40% in volume, and wherein the comminute feeding point is at least two length sections downstream of the second polymer feeding point in the material moving direction.

30. The method of claim 28, wherein the first thermoplastic polymer and the second polymer are selected among LMPAEK®, PEEK. and PEK.

31. The method of claim 21, wherein the second melting temperature is greater than the first melting temperature.

32. The method of claim 21, wherein the second melting temperature is lower than the first melting temperature.

33. The method of claim 32, wherein the first thermoplastic polymer is a poly(aryl ether ketone) and the second polymer is a PEI.

34. The method according to claim 21, comprising after step vii) a step viii) comprising bounding the second composite part to the structural part.

35. The method of claim 34, wherein the compound obtained in step vi) is a spooled wire and step vii) is carried out by additive manufacturing implementing a melting of the spooled wire.

36. The method of claim 34, wherein the compound obtained in step vi) is in a pellet form and step vii) is implemented by plastic injection molding.

37. The method of claim 34, wherein steps vii) and viii) are performed by overmolding the second composite part on the structural part.

38. The method of claim 34, wherein step viii) is implemented by welding the second composite part on the structural part.

39. The method of claim 34, wherein steps viii) is implemented by co-consolidating the second composite part and the structural part.
